(19) United States
(12) Patent Application Publication
(10) Pub. No.: US 2014/0187469 A1
(43) Pub. Date: Jul. 3, 2014

(54) AQUEOUS FORMULATION FOR DISPENSING AS A SPRAY POLYMERIC MICROCAPSULES CONTAINING AT LEAST ONE ACTIVE INGREDIENT

(71) Applicant: Suzanne Powell, Ashford (GB)

(72) Inventor: Suzanne Powell, Ashford (GB)

(21) Appl. No.: 13/261,821

(22) PCT Filed: Sep. 5, 2012
(86) PCT No.: PCT/GB12/00695

§ 371 Date: Mar. 3, 2014

(30) Foreign Application Priority Data
Sep. 9, 2011 (GB) 1115660.1

(51) Int. Cl. C11B 9/00

(52) U.S. Cl. CPC C11B 9/00
USPC 512/2

(57) ABSTRACT

An aqueous formulation for dispensing as a spray polymeric microcapsules containing at least one active ingredient, the aqueous formulation comprising: (i) water; (ii) polymeric microcapsules having an oil-soluble core containing the at least one active ingredient; (iii) a cross linked acrylic acid co-polymer; (iv) a neutralising amine for activating the cross linked acrylic acid copolymer to form a gel suspension for the polymeric microcapsules whereby the polymeric microcapsules are suspended in the water; (v) a chelant for protecting the aqueous formulation against destabilisation by excessive metal ions; and (vi) an inhibitor for inhibiting bacterial growth in the water.

This invention relates to an aqueous formulation and, more especially, this invention relates to an aqueous formulation for dispensing as a spray polymeric microcapsules containing at least one active ingredient.

Various types of aqueous formulations for dispensing at least one active ingredient are known. Among the known aqueous formulations are those employing polymeric microcapsules. The polymeric microcapsules have a polymeric coating which forms a shell around an oil-soluble core, which contains one or more active ingredients. The polymeric coating prevents degradation and/or evaporation of the one or more active ingredients in the oil-soluble core. The coating may be a melamine formaldehyde coating. Examples of polymeric microcapsules are disclosed in USA Patent Specification Nos. 20040072719 and 20040071746.

The aqueous formulations of polymeric microcapsules are required to be such that they spray evenly. The aqueous formulations may be sprayed onto textiles, other substrates, or used for room fragrancing. The aqueous formulations may be sprayed onto substrates such for example as textiles in textile finishing processes.

A problem exists with the above mentioned aqueous formulations when the dispensation of the polymeric microcapsules containing one or more active ingredients is to be in spray form. More specifically, there is a density difference between the polymeric microcapsules and the aqueous phase in which the polymeric microcapsules are suspended. A simple mixture of the polymeric microcapsules in water will separate into two layers, with the polymeric microcapsules forming the top layer. The separation into the two layers may occur over differing periods of time, from several hours to several days in dependence on the polymeric microcapsules employed. Whilst the two layer product can be shaken to re-form an even mixture due to the agitation, once the aqueous formulation is left standing, it will once again separate into the two layers.

In addition, the known aqueous formulations are such that the polymeric microcapsules have a tendency over time to aggregate together, forming larger aggregates of polymeric microcapsules consisting of single polymeric microcapsules stuck together. This may mean that instead of having single polymeric microcapsules having an average size of 3-10 microns, it is possible for the aqueous formulation to contain aggregates of polymeric microcapsules having an average size of more than 100 microns. Such aggregates become visible to the naked eye. If the aqueous formulations are dispensed on textiles, white spotting can occur which is extremely undesirable. The aggregates also create dispensing problems, since most spraying apparatus uses spray nozzles which operate best with a particle size below 40 microns.

It is an aim of the present invention to obviate or reduce the above mentioned problems.

Accordingly, in one non-limiting embodiment of the present invention there is provided an aqueous formulation for dispensing as a spray polymeric microcapsules containing at least one active ingredient, the aqueous formulation comprising:

(i) water;

(ii) polymeric microcapsules having an oil-soluble core containing the at least one active ingredient;

(iii) a cross linked acrylic acid co-polymer;

(iv) a neutralising amine for activating the cross linked acrylic acid co-polymer to form a gel suspension for the polymeric microcapsules whereby the polymeric microcapsules are suspended in the water;

(v) a chelant for protecting the aqueous formulation against destabilisation by excessive metal ions; and

(vi) an inhibitor for inhibiting bacterial growth in the water.

The aqueous formulation of the present invention is advantageous in that it enables the polymeric microcapsules to be suspended in the water such that the polymeric microcapsules remain in one dispersed phase over an extended period of time in order to give the aqueous formulation a reasonable shelf life. The extended period of time may be of several months. The aqueous formulation is also advantageous in that the gel reduces the tendency of the polymeric microcapsules to aggregate together and thereby enables the aqueous formulation to be sprayed more easily through spraying apparatus, even if the aqueous formulation has been standing for a period of time and is not shaken prior to being sprayed.

Preferably, the polymeric microcapsules are melamine formaldehyde microcapsules. Other types of polymeric microcapsules may be employed such for example as gelatin, urea formaldehyde or alginate microcapsules.

The cross linked acrylic acid co-polymer may be a C10-30 alkyl acrylate cross polymer. Such a C10-30 alkyl acrylate cross polymer is obtainable from Lubrizol as Carbopol Ultrez 20 polymer. (Carbopol is a Registered Trade Mark). The cross linked acrylic acid co-polymer is advantageous in that it has rapid wetting properties. Thus its use allows for rapid wetting and improved swelling time for the polymeric microcapsules, without the need for agitation, for example shaking, of the aqueous formulation prior to use. The cross linked acrylic acid co-polymer also advantageously enables very efficient thickening, for example providing moderate-to-high viscosity with smooth long flow properties.

Depending upon the loading of the polymeric microcapsules in the aqueous formulation, it is possible to vary the concentration of the cross linked acrylic acid co-polymer to achieve a stable suspension over an extended period of time.

The neutralising amine may be triethanolamine. Alternatively, the neutralising amine may be 2-amino 2-methyl 1-propanol. A preferred grade of 2-amino 2-methyl 1-propanol is that produced by Angus Chemical Company and sold under the Trade Mark AMP Ultra PC 3000.

The aqueous formulation may include a chelant for stabilising the aqueous formulation. The chelant stabilises the aqueous formulation against excessive metal ions. The chelant may be ethylenediaminetetraacetic acid (EDTA). A commercial grade EDTA is available from the Dow Chemical Company under the trade name Versene Na2 Crystals.

The aqueous formulation contains an inhibitor in order to inhibit bacterial growth in the water. The inhibitor may be an organic anti-microbial agent. The organic anti-microbial agent may be 2-bromo-2-nitropropane-1,3-diol. Other organic anti-microbial agents may be employed. The organic anti-microbial agent may be Bronopol, with Protectol BN 98 from BASF being a preferred grade.

Alternatively, the inhibitor may be an inorganic anti-microbial agent. The inorganic anti-microbial agent may be a silver anti-microbial agent. The silver anti-microbial agent may be a non-leaching metal particulate silver.

Preferably, the water is de-ionised water. This helps to stop bacterial growth and to limit the amount of metal ions present.

Other types of inorganic anti-microbial agents may be employed. Silver suspensions may be used. Preferred silver products are non-leaching metallic silver products such as the N9 pure silver products from N9 World Technologies Pvt, of Bangalore, India.

Any suitable active ingredient or mixture of oil soluble active ingredients may be employed in the polymeric microcapsules contained in the aqueous formulation of the present invention. Thus, for example, the active ingredient may be at least one fragrance ingredient, or a fully constructed fragrance consisting of numerous fragrance ingredients or essential oils. Alternatively, the active ingredient may be at least one cosmetic ingredient, or a blend of several cosmetic ingredients. The cosmetic ingredients may be combined with a fragrance.

The active ingredient may be one or more cosmetic active ingredients such for example as aloe vera or shea butter. The active ingredient may be an insect repellent. Other types of oil soluble active ingredients may be used.

The aqueous formulation may include a free fragrance oil which is solubilised with a fragrance solubiliser. The fragrance solubiliser may be, for example, a polysorbate-20.

The present invention also extends to spraying apparatus when containing the aqueous formulation of the invention.

The spraying apparatus may be an industrial sprayer for spraying large surface areas.

The industrial sprayer may be an electrically powered sprayer known as a fogger. Alternatively, the industrial sprayer may be a pressure pump.

Where the industrial sprayer is in an electrically powered sprayer, the electrically powered sprayer may project particles of the aqueous formulation in a size range of 15-40 microns for a distance up to 5 metres. Typical discharge levels may be 1-120 ml per minute. The means of propulsion is a flow of air over a feeder tube which causes a pressure differential and draws the aqueous formulation and atomises the aqueous formulation in the air flow. The airflow is created by a fan driven by an electric motor. The result is a delivery profile which is a constant flow whilst the power is being applied to the motor. Suitable devices for industrial use include “The Mini Fogger” supplied by Spray Systems, The Merlin Centre, Gatehouse Close, Aylesbury, Buckinghamshire, HP19 9DP United Kingdom.

Where the industrial sprayer is a pressure pump, the pressure pump may operate by building up a head of pressure in the pump, with the pressure being created by manual or electrical means to force the aqueous formulation containing the polymeric microcapsules through a nozzle. The sprayed aqueous formulation may be in the range of 30-60 microns, and it may travel for distances up to 1.5 metres. The delivery profile is a constant flow whilst the pressure is maintained in the vessel. Additional equipment which is suitable for such industrial use is the AeroFog 5 Lt, supplied by the above mentioned company of Spray Systems.

Where the spraying apparatus is to be a domestic spraying apparatus, then the domestic spraying apparatus may be employed to spray small quantities of the aqueous formulation in homes, for example to disperse aqueous formulations containing micro-encapsulated fragrances as room fresheners, or to refresh home textiles and soft furnishings, or to apply micro-encapsulated insect repellents to clothing or other textiles. Suitable domestic spraying apparatus may be the above mentioned hand-held trigger spraying apparatus. This type of apparatus is not pressurised and it is used for individual dose dispensations. The spray delivery is usually in the region of 0.2-0.5 g, and with a fine particle size. The spray usually travels for distances of 0.15-0.3 metre. The hand-held trigger spraying apparatus may employ containers in sizes of 10 ml-1 l. The hand-held trigger spraying apparatus will usually employ a fine misting nozzle.

If the spraying apparatus is in the form of pumping spraying apparatus, then the pumping spraying apparatus needs to be used with care because it may cause the aqueous formulation to shear on pumping. Only certain spray pumping apparatus may deliver an acceptable spray pattern. Unacceptable spray patterns may have holes in the middle, leading to dead zones which do not receive any spray. Unacceptable patterns also include jetting, dripping or droplets of unequal size. Suitable pump spraying apparatus are many hand-held trigger sprays, for example those supplied by Coster, with the specific pump reference number of 32MSPUP 26/20. When this was fitted to a spray bottle (reference V04.1433) a fine well dispersed spray was produced. Additional spray pumping apparatus may be obtained from Aptar Beauty and Home, such for example as the PZ2 pump, supplied with an actuator (PSK JZ1 V2).

The spraying apparatus, for example for industrial use or domestic use, may be a hand-held trigger spraying apparatus.

The spraying apparatus, for example for industrial use or domestic use, may alternatively be an aerosol. The aerosol may contain a propellant. The propellant may be dimethyl ether. Alternatively, the aerosol may comprise bag-on-valve means.

A preferred method of dispensing the aqueous formulation for individual or home use is to use spraying apparatus in the form of an aerosol. The spraying apparatus is able to give an ultra fine mist, ensuring no risk of spotting on fabrics or other substrates. A variety of propellant gases can be used in the aerosol including, for example compressed air or butane. A preferred propellant is di-methyl ether, since this propellant maintains a steady profile of delivery throughout the use of the aerosol, i.e. when the aerosol is full to when the aerosol is substantially empty.

The di-methyl ether is miscible with water to levels of up to 20%. The di-methyl ether is easily mixed with the remainder of the ingredients in the aqueous formulation of the present invention. Suitable aerosol devices are supplied by Swallowfield plc, Station Road, Wellington, Somerset TA21 8NL United Kingdom.

Where the aerosol comprises bag-on-valve means, then the aerosol may use butane or compressed air as the propellant. Performance throughout the life of the product is uniform, since no gas is lost.

The aqueous formulation of the present invention is able to achieve a stable profile even when stored for several months in aerosols. The aqueous formulation is also able always to be dispensed in a very fine mist pattern.

In order to facilitate a full understanding of the present invention, reference will now be made to the following Examples.

### EXAMPLE I

An aqueous formulation containing a 10% suspended spray formulation was made as follows:

Deionised water was measured out. To the water was added an anti-microbial agent in the form of Protectol BN 98, and a chelant in the form of Versene NA2 Crystals. To the resulting aqueous solution, was sprinkled a cross-linked acrylic acid co-polymer in the form of Carbopol Ultrez 20. The sprinkling was conducted on the surface of the aqueous solution. The aqueous solution was left for 10-20 minutes to wet out. The resulting aqueous solution was then stirred with a propeller stirrer until homogenous. To the mixture, was added polymeric microcapsules having an oil soluble core containing the active ingredient, and this was in the form of Blue Cloud fragrance polymeric microcapsules obtainable from Celessence Technologies Ltd. The mixture was stirred until it was homogenous. Sufficient neutralising amine in the form of AMP Ultra PC 3000 was added whilst stirring until a pH of 6.5 was reached.

The ingredients employed were as follows.

### To Make 1 L of a 10% Aqueous Formulation

| | | |
|---|---|---|
| 1. | Mix: | |
| | De-ionised Water | 850 g |
| | Protectol BN 98 | 1 g |
| | Versene NA2 Crystals | 1 g |
| 2. | Sprinkle on and leave for one hour: | |
| | Carbopol Ultrez 20 | 2.5 g |
| 3. | Mix and add capsules: | |
| | Blue Cloud Microcapsules | 100 g |
| 4. | Neutralise to pH 6.5: | |
| | AMP Ultra PC 3000 | g - as required |
| 5. | Top up to 1000 g with de-ionised water: | |
| | Add quantity required | g - as required |

### EXAMPLE II

A stable aqueous formulation was produced at a dilute concentration, in combination with free fragrance. Initially, De-ionised water was measured out. An inhibitor in the form of an anti-microbial agent known as Protectol BN and a chelant in the form of Versene Na2 crystals were added to the de-ionised water. To the aqueous solution was then sprinkled a cross linked acrylic acid co-polymer in the form of Carbopol Ultrez 20. The sprinkling was on the surface of the aqueous solution and the aqueous solution was left for 10-20 minutes to wet out. The aqueous solution was then stirred with a propeller stirrer until the aqueous solution was homogenous. To the mixture was then added vanilla fragranced polymeric microcapsules obtained from Celesence Technologies Ltd. The mixture was stirred until homogenous.

Separately, there were mixed together a free fragrance oil in the form of vanilla, and a fragrance solubliser in the form of Surfac 20. This blended mixture was then added to the bulk solution. Finally, sufficiently neutralising amine in the form of AMP Ultra PC 3000 was added whilst stirring until a pH of 6.5 was reached.

The ingredients employed were as follows.

### To Make 1 L of a Dilute Aqueous Formulation

| | | |
|---|---|---|
| 1. | Mix: | |
| | De-ionised Water | 900 g |
| | Protectol BN 98 | 0.5 g |
| | Versene NA2 Crystals | 1 g |
| 2. | Sprinkle on and leave for one hour: | |
| | Carbopol Ultrez 20 | 1 g |
| 3. | Mix and add polymeric microcapsules: | |
| | Vanilla polymeric microcapsules | 18 g |
| 4. | Separately, mix together: | |
| | Free fragrance oil (vanilla) and | 5 g |
| | Surfac T 20. Add blend to bulk | 10 g |
| | solution | |
| 5. | Neutralise to pH 6.5: | |
| | AMP Ultra PC 3000 | g - as required |
| 6. | Top up to 1000 g with de-ionsed water: | |
| | Add quantity required | g - as required |

It is to be appreciated that the embodiments of the invention described above with reference to the Examples have been given for purposes of illustration only. Individual ingredients and their weights in the aqueous formulations of the Examples may be used in all aspects of the invention.

1. An aqueous formulation for dispensing as a spray polymeric microcapsules containing at least one active ingredient, the aqueous formulation comprising:
(i) water;
(ii) polymeric microcapsules having an oil-soluble core containing the at least one active ingredient;
(iii) a cross linked acrylic acid co-polymer;
(iv) a neutralising amine for activating the cross linked acrylic acid co-polymer to form a gel suspension for the polymeric microcapsules whereby the polymeric microcapsules are suspended in the water;
(v) a chelant for protecting the aqueous formulation against destabilisation by excessive metal ions; and
(vi) an inhibitor for inhibiting bacterial growth in the water.

2. An aqueous formulation according to claim 1 in which the polymeric microcapsules are melamine formaldehyde microcapsules.

3. An aqueous formulation according to claim 1 in which the cross linked acrylic acid co-polymer is a C10-30 alkyl acrylate cross polymer.

4. An aqueous formulation according to claim 1 in which the neutralising amine is triethanolamine or 2-amino 2-methyl 1-propanol.

5. (canceled)

6. An aqueous formulation according to any one of the preceding claims in which the chelant is ethylenediaminetetraacetic acid (EDTA).

7. An aqueous formulation according to claim 1 in which the inhibitor is an organic anti-microbial agent.

8. An aqueous formulation according to claim 6 in which the organic antimicrobial agent is 2-bromo 2-nitopropane -1,3-diol.

9. An aqueous formulation according to claim 1 in which the inhibitor is an inorganic anti-microbial agent.

10. An aqueous formulation according to claim 8 in which the inorganic anti-microbial agent is a silver anti-microbial agent.

11. An aqueous formulation according to claim 9 in which the silver antimicrobial agent is a non-leaching metal particulate silver.

12. An aqueous formulation according to claim 1 in which the water is de-ionised water.

13. An aqueous formulation according to claim 1 in which the polymeric microcapsules contain an active ingredient which is a fragrance, at least one cosmetic ingredient, or an insect repellent.

14-16. (canceled)

17. An aqueous formulation according to claim 1 and including free fragrance oil which is solubilised with a fragrance solubiliser.

18. An aqueous formulation according to claim 13 in which the fragrance solubiliser is a polysorbate-20.

19. Spraying apparatus when containing an aqueous formulation according to any one of the preceding claims.

20. Spraying apparatus according to claim 19 in which the spraying apparatus is an industrial sprayer for spraying large surface areas.

21. Spraying apparatus according to claim 20 in which the industrial sprayer is a fogger or a pressure pump.

22. (canceled)

23. Spraying apparatus according to claim 16 in which the spraying apparatus is a hand-held trigger spraying apparatus.

24. Spraying apparatus according to 18 in which the spraying apparatus is an aerosol.

25-26. (canceled)

27. Spraying apparatus according to claim 24 in which the aerosol comprises bag-on-valve means.
